(19) United States
(12) Patent Application Publication
(10) Pub. No.: US 2012/0175391 A1
(43) Pub. Date: Jul. 12, 2012

(54) Multi-mount system for removably securing articles to garments

(75) Inventors: William H. Rogers, St. Augustine, FL (US); Matthew E. McKendrick, Jacksonville, FL (US)

(73) Assignee: Prezine, LLC

(21) Appl. No.: 12/316,564

(22) Filed: Dec. 12, 2008

Related U.S. Application Data
(60) Provisional application No. 61/007,855, filed on Dec. 17, 2007.

(51) Int. Cl. A45F 5/02; B23P 11/02

(52) U.S. Cl. 224/182; 224/191; 29/453; 29/426.2

(57) ABSTRACT

A multi-mount system, including a receiver as one component of the system, for removably attaching articles to a garment. The receiver has openings for affixing the receiver to a device that is then secured to a device-compatible garment. An article, such as a holster, is affixed to an attachment mount that is then inserted into the receiver in locking engagement therewith. The receiver can also be attached to a platform, which is then secured to a garment. The receiver can also be attached to a second mount, which is then secured to a garment. The receiver can further be attached to other devices, such as a backing plate and waist belt. The mount and its affixed article can be quickly relocated to another receiver by compressing resilient outer tines of the mount and withdrawing the mount and then inserting it into another open receiver on the user's person.

### CROSS-REFERENCE TO RELATED APPLICATION

This application claims priority to provisional application 61/007,855, filed Dec. 17, 2007, entitled Multi-Mount Systems for Accessories Attachable to Garments (Attorney Docket Number D-7804).

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

This invention relates generally to connectors, fasteners, and attaching systems to secure articles to a garment or the like, and more particularly to a receiver for aiding in quickly removing and securing holsters, pouches, or other modular accessories to a MOLLE/PALS-compliant garment or to a non-compliant garment such as a harness, waist belt, or leg belt.

2. Relevant Art

MOLLE is an acronym for MOdular Lightweight Load-carrying Equipment and defines the current generation of load-bearing equipment and rucksacks utilized by the United States Army. The modularity of the system is derived from the use of Pouch Attachment Ladder System or PALS webbing, rows of heavy-duty nylon precisely stitched onto the vest so as to allow for attachment of various MOLLE-compatible pouches and articles. This method of attachment has generally become a standard for all quality modular military gear, replacing the click and stick system used in the earliest modular vest systems (which is still in use by most Western police departments), and is produced for the United States Government under contract by several contractors. See, for example, U.S. Pat. No. 5,724,707.

PALS is a grid of webbing invented and patented by the United States Army Natick Soldier Research, Development, and Engineering Center and is used to attach smaller equipment onto load-bearing platforms, such as vests and backpacks. See, for example, U.S. Pat. Nos. 7,080,430; 7,200,871; and 7,240,404. PALS webbing was first used on MOLLE rucksacks, but is now found on a variety of American equipment, such as the Improved Outer Tactical Vest, Interceptor body armor, USMC Improved Load Bearing Equipment backpack, and Modular Tactical Vest. PALS webbing is used to readily attach items such as holsters, magazine pouches, radio pouches, knife sheaths, and other gear. A wide variety of pouches are commercially available, allowing soldiers to customize their kit. There are also a variety of attachment methods, including the Malice Clip, the Natick snap, and soft, interwoven straps. The PALS system has been adopted by other forces, such as the British Army, who use it on their Osprey body armor.

The PALS webbing grid consists of horizontal rows of one inch Mil-W-43668 Type Ill nylon webbing (most commercial vendors use Type 111a), spaced one inch apart, and reattached by reinforced stitches or seams to the backing at one and one-half inch intervals.

There have been numerous designs developed so that the user can securely attach an article to the MOLLE/PALS system. These designs can take considerable time to secure and remove the article. Most of the new designs use additional parts to interlock to the PALS system, while the older products use lacing fabric straps. These designs are secure but in many cases are unstable, allowing for a great deal of movement. For articles such as hydration bags or radio pouches movement is usually not a detriment. Attachment of a handgun holster for quick deployment of the handgun, however, can be a different matter.

While a user is traveling in a vehicle, it can be advantageous to wear a holster with handgun on the front of a vest. Once deployed and on foot, however, the user might prefer that the handgun be mounted elsewhere on the body. Present attachment designs generally require the removal of the garment in order to remove the article.

What is needed is a stable mount for an article, such as a holster with a handgun, that allows the user to quickly get a proper grip on the handgun and release it from the holster. There is also a need to be able to quickly remove the holster from the PALS webbing without first removing the garment from the user's body. Once removed, it should be possible to quickly place the holster on some other part of the garment or on a different suitable garment worn on the body.

### SUMMARY OF THE INVENTION

The present invention provides a receiver designed to help a user quickly attach an article, such as a holster, knife, magazine, or the like, either to a MOLLE/PALS compliant garment or to a non-compliant garment such as a waist belt, shoulder harness, or leg belt, and to quickly detach the article from same. To accomplish this, the receiver is used in conjunction with certain other devices.

One device with which the receiver is used is an attachment mount, such as is described in our co-pending application entitled Attachment Mount System For Removably Securing Articles To MOLLE/PALS-Compliant Garments (Attorney Docket Number D-7803), filed herewith, which patent application is incorporated herein by reference. The receiver is configured to allow the attachment mount to slide into the receiver and lock in place. To remove the attachment mount from the receiver, resilient outer tines of the attachment mount are compressed and the attachment mount withdrawn. Generally, an article will be secured to a freed attachment mount before the attachment mount is inserted into the receiver. Also, generally before the attachment mount is inserted within the receiver, the receiver is attached to a MOLLE/PALS-compliant garment or to a non-compliant garment. Other devices are also used to aid in this.

One such device is a second attachment mount. The receiver is attached to the second attachment mount, and the second attachment mount is then removably secured to a MOLLE/PALS-compliant garment. The original attachment mount, with its affixed article, is then inserted into the receiver, thereby removably securing the article to the garment.

Another device used to attach the receiver to a MOLLE/PALS-compliant garment is a platform, such as is described in our co-pending application entitled Universal Mounting Platform And Method For Attaching Same To Garments (Attorney Docket Number D-7802), filed herewith, which patent application is incorporated herein by reference. The receiver is attached to the platform, and the platform is then removably secured to a MOLLE/PALS-compliant garment. An attachment mount, to which an article has been affixed, is then inserted into the receiver, thereby removably securing the article to the garment.

Another group of devices is used to attach the receiver to a non-compliant garment. This group includes such devices as a backing plate combined with a waist belt, shoulder harness, or leg belt. The receiver is first attached to a device, such as a backing plate secured to a waist belt. Then an attachment mount, to which an article has been affixed, is inserted into the receiver, thereby removably securing the article to the backing plate and waist belt.

With an article such as a handgun holster affixed to an attachment mount, and with multiple receivers attached to one or more garments on the body, a user can quickly move the article from place to place about the body. The attachment mount, with its affixed article, can quickly be withdrawn from one receiver and inserted into another receiver. For example, an attachment mount and an affixed holster with handgun can be moved quickly from a receiver on a user's MOLLE/PALS-compliant vest to a receiver on the user's non-compliant waist belt. A magazine pouch or some other article can then be mounted into the receiver on the vest from where the holster was just removed. In this way, the user can quickly organize the vest and waist belt for a specific mission.

A receiver can also be equipped with a spline. When attached to a device having a compatible spline, the receiver can be secured to the device at a variety of angles relative to the device.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description taken in connection with the accompanying drawings, in which:

FIG. 1 is a front elevational view of the receiver component of the multi-mount system according to this invention;

FIG. 2 is a right side elevational view thereof;

FIG. 3 is a rear elevational view thereof;

FIG. 4 is a bottom plan view thereof;

FIG. 5 is a front perspective view thereof;

FIG. 6 is a rear perspective view thereof;

FIG. 7 is a front elevational view of an attachment mount used with the multi-mount system according to this invention, inserted into the receiver;

FIG. 8 is an exploded front elevational view of the attachment mount of FIG. 7 withdrawn from the receiver of FIG. 1;

FIG. 9 is a front perspective view of a holster and handgun with the attachment mount attached to the holster and the attachment mount inserted into the receiver and the receiver attached to and carried on a platform used with the multi-mount system according to this invention;

FIG. 10 is a rear perspective view of FIG. 9;

FIG. 11 is a front elevational view of the platform of FIG. 9 attached to a MOLLE/PALS-compliant garment;

FIG. 12 is a cross-sectional view taken along line 11-11 of FIG. 11;

FIG. 13 is a front perspective view of a holster and handgun with the attachment mount attached to the holster inserted into the receiver and the receiver attached to and carried by a waist belt backing plate, the lower portion thereof having slots for receiving a thigh encircling strap or the like;

FIG. 14 is a rear perspective view of FIG. 13;

FIG. 15 is a front elevational view of the attachment mount of FIG. 7 inserted onto webbing of a MOLLE/PALS-compliant garment;

FIG. 16 is a front elevational view of a second embodiment of a receiver, in accord with the present invention;

FIG. 17 is a right side elevational view thereof; and

FIG. 18 is a rear elevational view thereof.

### DETAILED DESCRIPTION OF THE PRESENT INVENTION

It should be noted that as defined herein, the term “device” may include a platform, an attachment mount, a backing plate of a holster, or an attachment to a waist or utility belt, as well as other similar supports.

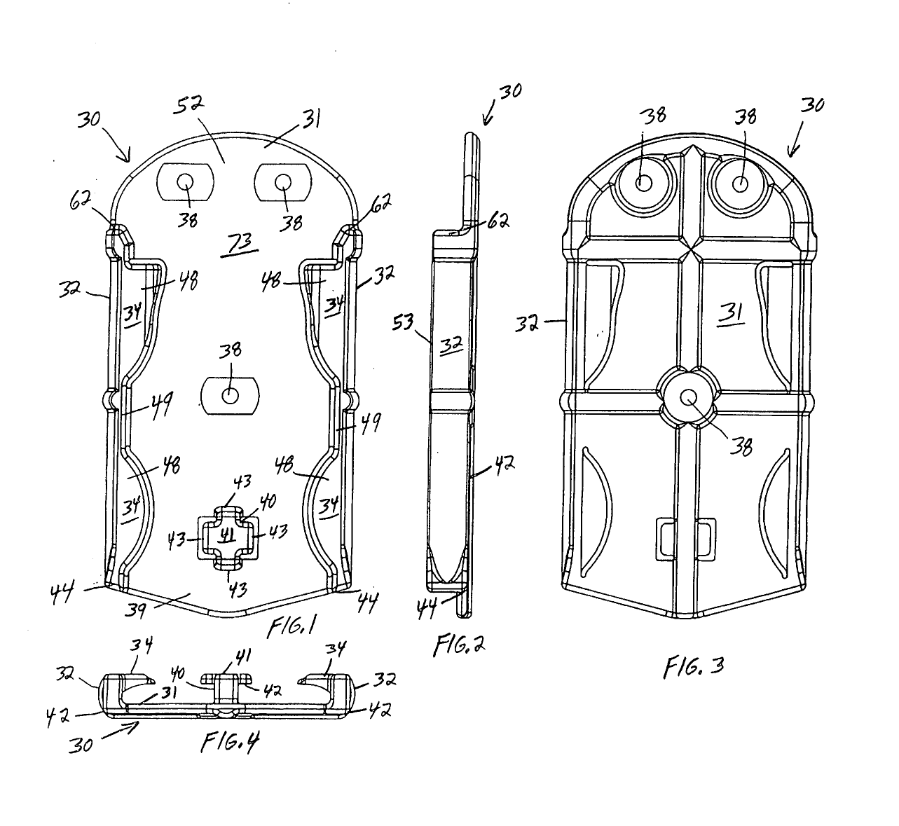

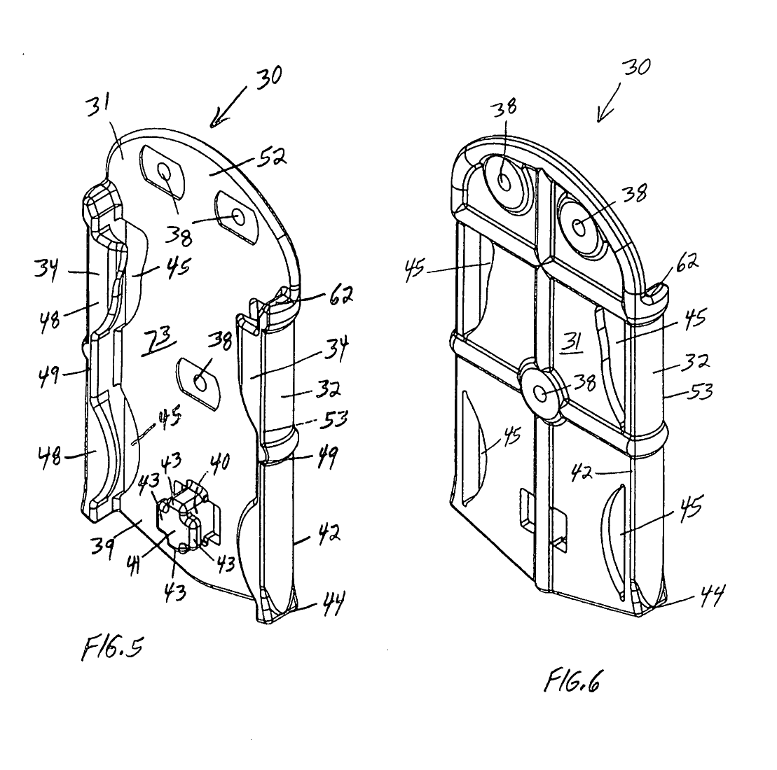

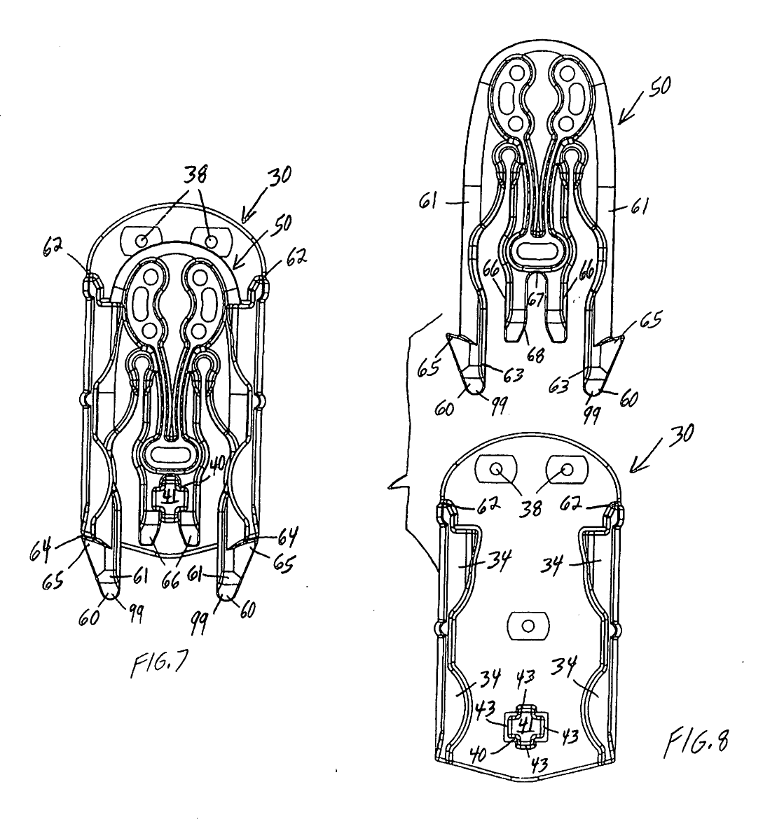

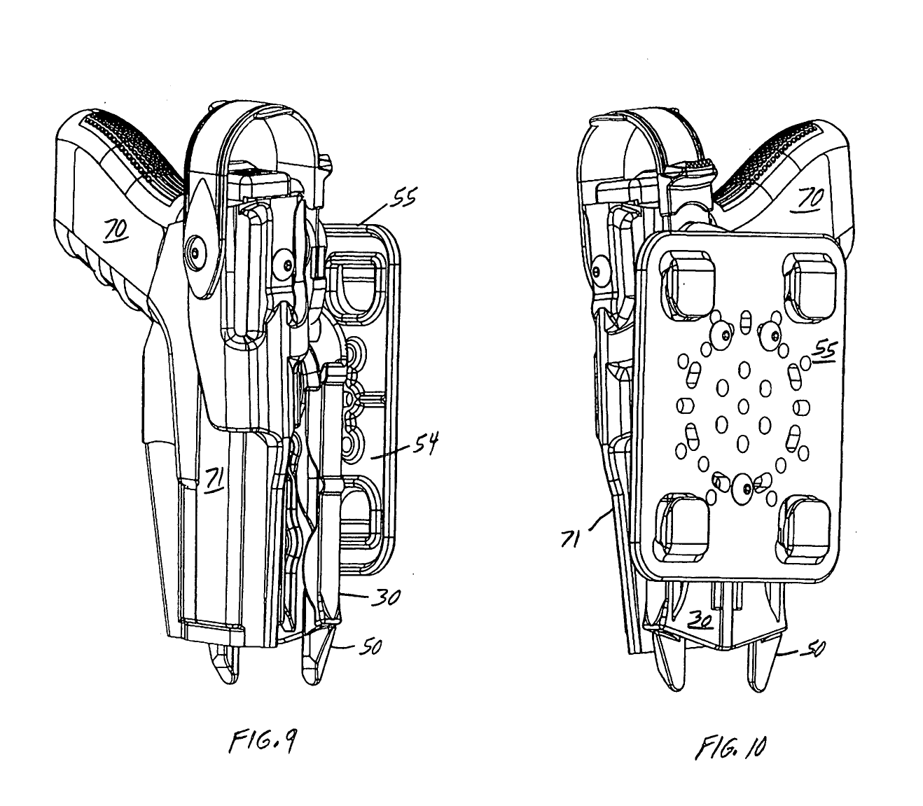

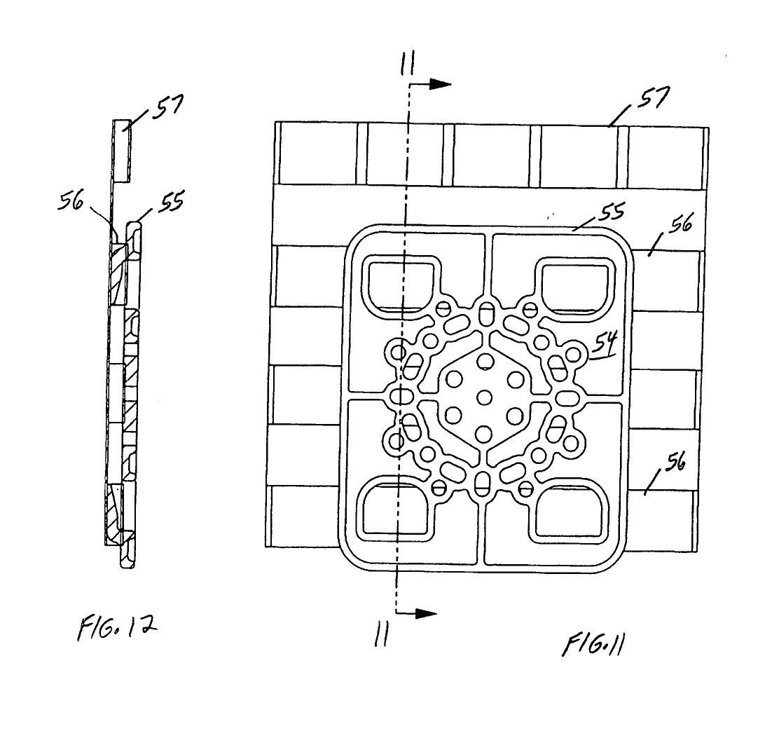

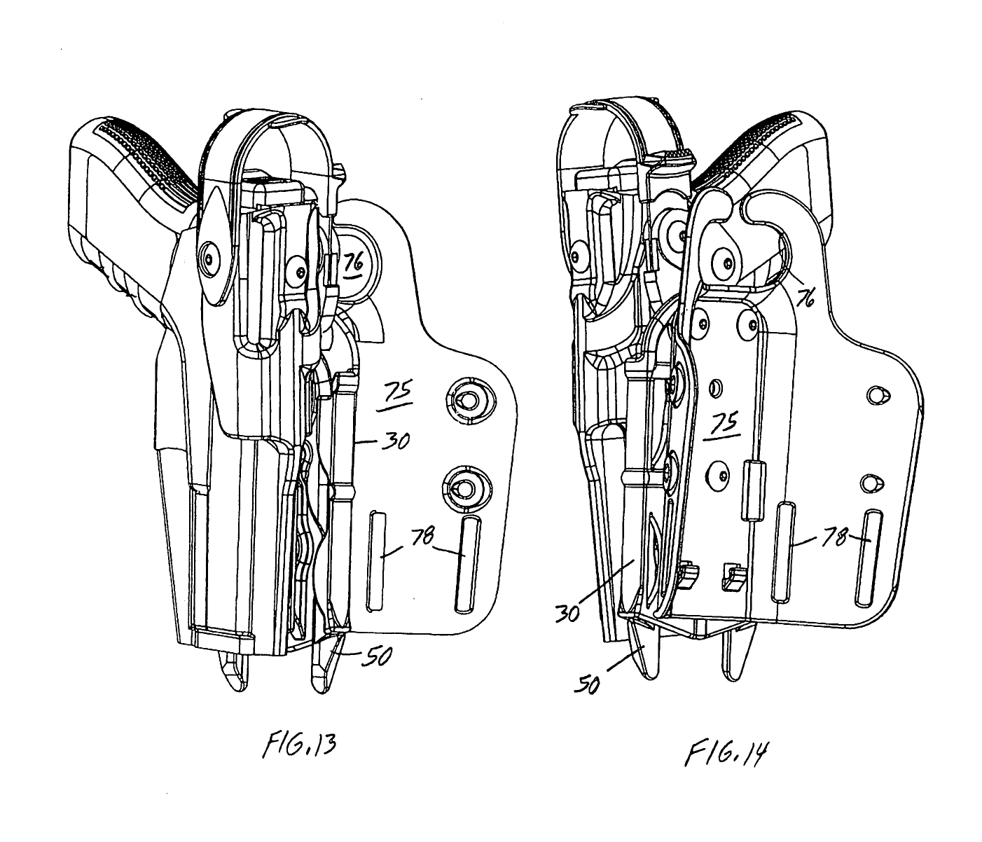

Embodying the principles of the present invention is a receiver, a preferred embodiment of which is depicted in FIGS. 1-15 and designated generally by reference numeral 30. The receiver 30 is capable of engaging with other devices so as to permit articles to be removably secured to a garment, as will be explained hereinbelow.

Referring now to FIGS. 1-6, the receiver 30 is principally made of a rigid plastic material and includes a planar member 31 (see FIGS. 1, 3, 4, 5, and 6). The planar member 31, itself, includes spaced areas 45 (see FIGS. 5 and 6) to reduce the amount of plastic material and weight, as is well known in the injection molding art. The planar member 31 also includes a hole pattern 38 (see FIGS. 1, 3, 5, and 6) that contains a plurality of spaced openings that extend through the planar member 31 for affixing the receiver 30 to a device. The device, in turn, can be attached to a garment, as described below with reference to FIGS. 9-15. Note that other embodiments include a hole pattern 38 in which spaced openings appear in various forms and arrangements so to accommodate a given device intended to support the receiver 30.

Continuing with FIGS. 1-6, the receiver 30 also includes a spaced pair of opposing side walls 32 and a spaced pair of opposing flanges 34 (see FIGS. 1, 4, and 5). The side walls 32 reach approximately the length of the receiver 30, with each side wall 32 extending generally laterally from a respective side 42 (see FIGS. 2, 4, 5, and 6) of the planar member 31. Each side wall 32 is formed integrally with the respective side 42. The opposing flanges 34 are used for capturing and maintaining an attachment mount 50, wherein the attachment mount 50 is slidingly positioned within the receiver 30, as described below with reference to FIGS. 7 and 8. The flanges 34 are generally the same height as the side walls 32 with each flange 34 reaching from approximately an upper edge 62 (see FIGS. 1, 2, 5, and 6) of a respective side wall 32 to approximately a lower edge 44 (see FIGS. 1, 2, 5, and 6) of the respective side wall 32. Each flange 34 extends generally laterally from a side 53 (see FIGS. 2, 5, and 6) of the respective side wall 32, reaching inwardly toward the other flange 34. The flanges 34 are spaced from the planar member 31 and oriented substantially parallel with it. Each flange 34 is formed integrally with the side 53 of the respective side wall 32. To reduce the amount of material and weight of the receiver 30, each flange 34 also includes a narrow middle portion 49 (see FIGS. 1, 4, and 5) between wider opposing end portions 48 (see FIGS. 1 and 5). Note, however, that in other embodiments flanges 34 do not always have a narrower middle portion 49.

Still referring to FIGS. 1-6, the receiver 30 further includes an upstanding post member 40 (see FIGS. 1, 4, and 5) located adjacent a lower portion 39 (see FIGS. 1 and 5) of the planar member 31. The post member 40 includes an enlarged head 41 (see FIGS. 1, 4, and 5) with a lower surface 42 (see FIG. 4). The lower surface 42 of the enlarged head 41 is substantially parallel to a front face 73 (see FIGS. 1 and 5) of the planar member 31. The enlarged head 41 also includes four spaced shoulders 43 (see FIGS. 1 and 5). A first shoulder 43 extends substantially toward one flange 34, while a second shoulder 43 extends substantially toward the opposing flange 34. A third shoulder 43 extends substantially toward the lower portion 39 of the planar member 31, while a fourth shoulder 43 extends in substantially the opposite direction toward an upper portion 52 (see FIGS. 1 and 5) of the planar member 31. When the attachment mount 50 (see FIGS. 7 and 8) is inserted within the receiver 30, a spaced pair of inner tines 66 (see FIGS. 7 and 8) of the attachment mount 50 become nested between the planar member 31 and the first and second shoulders 43 of the enlarged head 41. In this position, substantial movement of the attachment mount 50 is not possible until the attachment mount 50 is released from the receiver 30, as described below with reference to FIGS. 7 and 8. Note that in other embodiments, an enlarged head 41 includes at least two spaced shoulders 43, but not necessarily four spaced shoulders 43. Note also that in other embodiments, an enlarged head 41 takes a different form.

FIGS. 7-15 show the receiver 30 (see FIGS. 7-10, 13, and 14) used in conjunction with other devices. One of these devices is an attachment mount 50 (see FIGS. 7-10 and 13-15) that can be inserted within the receiver 30, as shown in FIGS. 7 and 8. The receiver 30 can also be attached to other devices. These other devices can themselves be attached either to a MOLLE/PALS-compliant garment 57 (see FIGS, 11, 12, and 15) or to a non-compliant garment, depending upon the device.

Referring now to FIGS. 7 and 8, the receiver 30 is configured to slidingly receive an attachment mount 50, whereupon the receiver 30 and the attachment mount 50 are releasably engaged. Each of the two outer tines 61 of the attachment mount 50 includes a curved lower end 60. When the attachment mount 50 is initially inserted into the receiver 30, the curved lower ends 60 of the outer tines 61 engage upper edges 62 of the side walls of the receiver 30. As the attachment mount 50 is slidingly moved down into the receiver 30, lower end portions 63 of the outer tines 61 are forced inwardly, compressing the outer tines 61 toward each other and allowing the attachment mount 50 to continue into the receiver 30. When the lower end portions 63 (see FIG. 8) of the outer tines 61 pass completely through the receiver 30, barbs 65 of the outer tines 61 resiliently move outwardly to engage lower stops 64 (see FIG. 7) of the receiver 30, as shown in FIG. 7. Simultaneously, inner tines 66 of the attachment mount 50 straddle the post 40 of the receiver 30 to dispose the post 40 at an upper end 67 (see FIG. 8) of a bifurcation 68 (see FIG. 8) of the inner tines 66, thereby locking the attachment mount 50 in the receiver 30. The inner tines 66 are now positioned to resist horizontal movement, the barbs 65 are now positioned to resist upward movement, and the post 40 nested in the upper end 67 of the bifurcation 68 is now positioned to resist further downward movement.

Continuing with FIGS. 7 and 8, to release the attachment mount 50 from the receiver 30, a user grabs the lower end portions 63 of the outer tines 61 of the attachment mount 50 and compresses the outer tines 61 toward each other. This forces the barbs 65 of the outer tines 61 to clear the lower stops 64 of the receiver 30. While continuing to compress the outer tines 61, the user withdraws the attachment mount 50 upwardly until the barbs 65 clear the lower stops 64. This releases the locking engagement of the barbs 65 with the lower stops 64. The attachment mount 50 can now be withdrawn upwardly out of the receiver 30, as illustrated in FIG. 8.

Referring now to FIGS. 9 and 10, a holster 71 with handgun 70 is affixed to the attachment mount 50 by passing one or more connectors (not shown) through selected openings in the attachment mount 50 and through openings in the holster 71, as can be more fully understood by referring to our co-pending application (D-7803). This ensures that the holster 71 will remain with the attachment mount 50 when the attachment mount 50 is moved.

Referring now to FIGS. 9-12, the receiver 30 (see FIGS. 9 and 10) is attached to a platform 55 by passing one or more connectors (not shown) through the spaced openings of the hole pattern 38 (see FIGS. 1, 3, 5, and 6) of the planar member 31 (see FIGS. 1, 3, 4, 5, and 6) of the receiver 30 and then through openings in a plate member 54 (see FIGS. 9 and 11) of the platform 55. As understood in the art, if two or more of the openings of the hole pattern 38 are used to attach the receiver 30 to the platform 55, then the receiver 30 will be in a locked position on the platform 55. The platform 55 is then releasably secured to webbing 56 (see FIGS. 11 and 12) of a MOLLE/PALS-compliant garment 57 (see FIGS. 11 and 12), as described in our co-pending application (D-7802). This, in effect, releasably secures the receiver 30 to the garment 57 as well. The attachment mount 50 (see FIGS. 9 and 10), with its affixed holster 71 (see FIGS. 9 and 10) and handgun 70 (see FIGS. 9 and 10), is then inserted into the receiver 30. In this way, the holster 71 and handgun 70 become releasably secured to the garment 57 by way of the attachment mount 50 and the receiver 30.

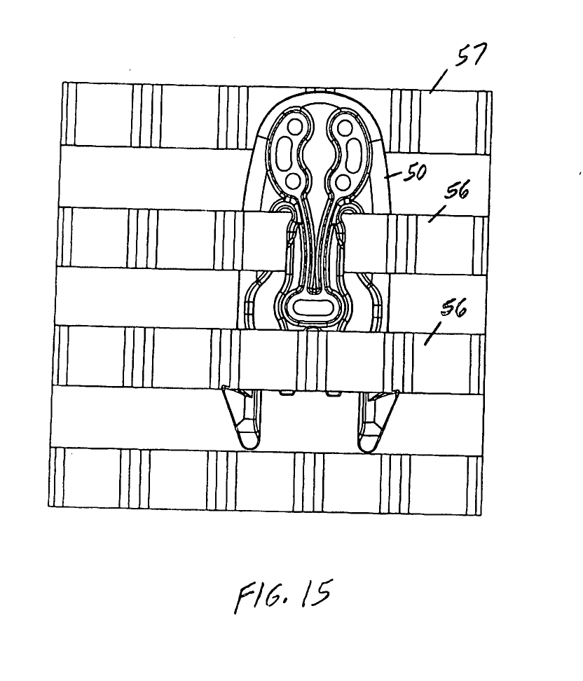

Referring now to FIGS. 13 and 14, the receiver 30 is attached to a backing plate or leg plate 75 of a waist belt (not shown) by passing one or more connectors (not shown) through the spaced openings of the hole pattern 38 (see FIGS. 1, 3, 5, and 6) of the planar member 31 (see FIGS. 1, 3, 4, 5, and 6) of the receiver 30 and then through openings in the plate 75. The waist belt passes through a belt loop 76 of the plate 75, while lower spaced slots 78 in the plate 75 receive another belt or thigh strapping (not shown) to secure the plate 75 in position on the waist and thigh. The attachment mount 50, with its affixed holster 71 and handgun 70, is then inserted into the receiver 30. In this way, the holster 71 and handgun 70 become secured to the plate 75 and waist belt by way of the attachment mount 50 and the receiver 30.

Referring now to FIGS. 9 and 10, note that although the receiver 30 is shown as attached to the platform 80, it is also possible that the receiver 30 can be attached to a second attachment mount 50 instead of the platform 80. In such case, the second attachment mount 50 would then be releasably secured to webbing 56 of a MOLLE/PALS-compliant garment 57, as shown in FIG. 15 and as described in our co-pending application (D-7803). This, in effect, would releasably secure the receiver 30 to the garment 57. The original attachment mount 50, with its affixed holster 71 and handgun 70, could then be inserted into the receiver 30. In this way, the holster 71 and handgun 70 would become releasably secured to the garment 57 by way of the second attachment mount 50 and the receiver 30. Note also that with the attachment of the receiver 30 to a second attachment mount 50, a recursive grouping is initiated in which the second attachment mount 50 can now be inserted into a second receiver 30. This second receiver 30 can then, itself, be attached to a third attachment mount 50. The third attachment mount 50 can then be inserted into a third receiver 30, and so on. In theory, any number of receivers 30 and attachment mounts 50 can be grouped together in this manner. In practice, however, groupings that include more than one receiver 30 generally prove impractical.

Continuing with FIGS. 9 and 10, to release the attachment mount 50 from the receiver 30, a user grabs the lower end portions 63 (see FIGS. 7 and 8) of the outer tines 61 (see FIGS. 7 and 8) of the attachment mount 50 and compresses the outer tines 61 toward each other while simultaneously pulling on the handgun 70, as similarly described above with reference to FIGS. 7 and 8. This releases the attachment mount 50 with its holster 71 and handgun 70 from the receiver 30. The attachment mount 50 can now be inserted into another like receiver 30, as would occur to those skilled in the art. For example, an attachment mount 50 can be removed from a receiver 30 that is attached to a platform 80 that, in turn, is attached to a MOLLE/PALS-compliant garment 57, as described above with reference to FIG. 9-12, and inserted into another receiver 30 that is attached to a backing plate 75 that is secured to a non-compliant waist belt, as described above with reference to FIGS. 13 and 14.

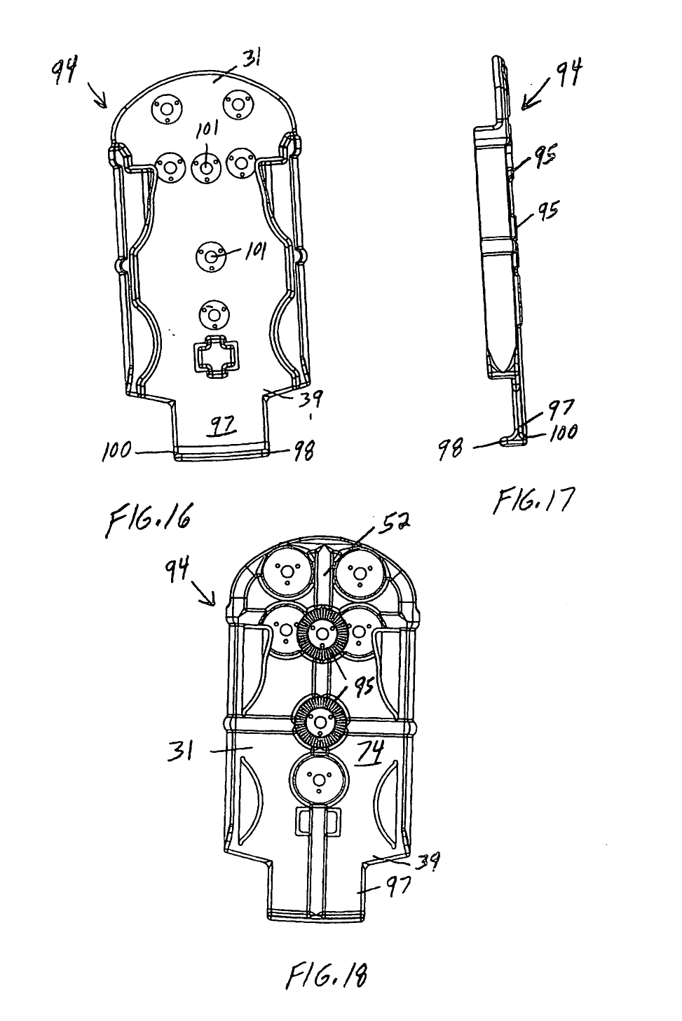

FIGS. 16-18 depict a second preferred embodiment of a receiver, designated generally by reference numeral 94, in accordance with the present invention. The receiver 94 of the present embodiment includes an extended lower portion 97 and a ledge 98 that makes the receiver 94 longer than the receiver 30 (see FIGS. 1-15) of the first preferred embodiment. The receiver 94 of the present embodiment also includes a spaced pair of locking splines 95 (see FIG. 18) that provide a further way of engaging with other devices to permit articles to be removably secured to a garment. Apart from these differences, however, the receiver 94 of the present embodiment is substantially the same as the receiver 30 of the first preferred embodiment.

Referring now to FIGS. 16-18, the extended lower portion 97 of the receiver 94 extends downwardly from a lower portion 39 (see FIGS. 16 and 18) of the planar member 31 (see FIGS. 16 and 18). A ledge 98 (see FIGS. 16 and 17) is formed integrally with a bottom end 100 (see FIGS. 16 and 17) of the extended lower portion 97 and extends in a generally perpendicular direction from the extended lower portion 97. The ledge 98 covers lower tips 99 (see FIGS. 7 and 8) of outer tines 61 (see FIGS. 7 and 8) of the attachment mount 50 (see FIGS. 7, 8, and 15) to deter puncturing seats and the like.

Continuing with FIGS. 16-18, the splines 95 (see FIG. 18) of the receiver 94 are molded to a rear face 74 (see FIG. 18) of the planar member 31 of the receiver 94. A first spline 95 is proximate to the upper portion 52 (see FIG. 18) of the planar member 31 and surrounds an attaching hole 101(see FIG. 16), while a second spline 95 is located medially of the rear face 74 and surrounds a second attaching hole 101. Each spline 95 can engage a compatible spline of a device (not shown). A connector (not shown) can be passed through the attaching hole 101 of a respective spline 95 to attach the receiver 94 to the device.

Still referring to FIGS. 16-18, the splines 95 of the receiver 94 offer a variety of attachment points for attaching the receiver 94 to a device. This variety of attachment points allows for greater flexibility in centering the mass of the device when attaching the device to the receiver 94, thereby providing for more stable positioning. A device with a compatible spline can engage either of the splines 95 of the receiver 94 to dispose the receiver 94 in a number of angled positions relative to the device. The splines 95 of the receiver 94 permit angular relationships in increments of approximately fifteen degrees between the receiver 94 and the device. Of course, if the device includes two compatible splines and both splines are affixed to both splines 95 of the receiver 94, then the angled positions that the receiver 94 can assume will likely be limited to only two positions, one position approximately one-hundred-eighty degrees relative to the other position.

Regarding FIGS. 16-18, one type of device to which the receiver 94 can be attached is a platform 80, as described above with reference to FIGS. 9-12. The platform 80 can contain a spline compatible with the splines 95 of the receiver 94, as described in our co-pending application (D-7802). Another type of device to which the receiver 94 can be attached is an attachment mount 50, as described above with reference to FIGS. 9 and 10. The attachment mount 50 also contains a spline compatible with the splines 95 of the receiver 94, as described in our co-pending application (D-7803). Both the hole pattern 38 and the splines 95 of the receiver 94 offer a number of different attachment possibilities that permit the receiver 94 to be attached to many differently-configured devices and the like. Note that in other embodiments, a receiver 94 has only one spline 95.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

What is claimed as new and what it is desired to secure by Letters Patent of the United States is:

1. A receiver for removably securing articles to a garment comprising:
a planar member having a plurality of spaced openings extending therethrough for affixing said planar member to a device attachable to a garment;
a spaced pair of elongated opposing side walls, each said side wall attached with and extending generally laterally from an opposing side of said planar member, said side walls extending in substantially the same direction; and
a spaced pair of opposing flanges, said flanges extending inwardly generally laterally from respective said side walls, said flanges being oriented substantially parallel with and spaced from a front face of said planar member.

2. The receiver as defined in claim 1, further comprising an upstanding post member located adjacent and connected to a lower portion of said planar member for holding an attachment mount releasably engaged substantially within said side walls, said post member being straddled by a spaced pair of inner tines of an attachment mount to locate a pair of inner tines on opposed surfaces of said post member.

3. The receiver as defined in claim 2, wherein said post member includes a spaced pair of shoulders disposed spacedly from said planar member for nesting a spaced pair of inner tines of an attachment mount between said shoulders and said planar member, said shoulders extending substantially toward respective said flanges, said shoulders being substantially parallel to said planar member.

4. The receiver as defined in claim 3, wherein:
said planar member of said receiver further includes an extended lower portion narrower in width than said planar member;
said extended lower portion having a bottom end substantially perpendicular to said side walls of said receiver and an integral ledge extending generally laterally from said bottom end in substantially the same direction as said side walls and generally perpendicular thereto, said ledge being located at a position at least equal to the location of lower tips of outside tines of an attachment mount to deter potential puncture incidents caused by lower tips of outside tines.

5. The receiver as defined in claim 4, wherein a rear face of said planar member of said receiver opposing said front face of said planar member includes a locking spline having a plurality of ridges and valleys extending radially, said spline being formed integrally with said rear face and surrounding an attaching hole extending through said planar member for affixing said receiver to a complemental spline on a device allowing said receiver to be affixed at a plurality of angles relative to such device.

6. The receiver as defined in claim 1, wherein said planar member includes a plurality of spaced openings therethrough to accommodate T-nut and bolt connectors for affixing said receiver to a device.

7. The receiver as defined in claim 3, wherein a rear face of said planar member of said receiver opposing said front face of said planar member includes a locking spline having a plurality of ridges and valleys extending radially, said spline being formed integrally with said rear face and surrounding an attaching hole extending through said planar member for affixing said receiver to a complemental spline on a device allowing said receiver to be affixed at a plurality of angles relative to such device.

8. The receiver as defined in claim 1, wherein:
said planar member of said receiver further includes an extended lower portion narrower in width than said planar member;
said extended lower portion having a bottom end substantially perpendicular to said side walls of said receiver and an integral ledge extending generally laterally from said bottom end in substantially the same direction as said side walls and generally perpendicular thereto, said ledge being located at a position at least equal to the location of lower tips of outside tines of an attachment mount to deter potential puncture incidents caused by lower tips of outside tines.

9. The receiver as defined in claim 8, wherein a rear face of said planar member of said receiver opposing said front face of said planar member includes a locking spline having a plurality of ridges and valleys extending radially, said spline being formed integrally with said rear face and surrounding an attaching hole extending through said planar member for affixing said receiver to a complemental spline on a device allowing said receiver to be affixed at a plurality of angles relative to such device.

10. A system for removably securing an article to a device attachable to a garment on a body of a user comprising:
a receiver;
a substantially planar attachment mount including:
an attachment member having an upper portion and an inner tine body narrower in width than said upper portion, said inner tine body extending generally laterally from said upper portion;
a spaced pair of generally parallel inner tines formed integrally with said inner tine body and extending generally laterally therefrom;
a spaced pair of generally parallel outer tines for removably securing said attachment mount substantially within said receiver, said outer tines formed integrally with said upper portion of said attachment member and extending generally laterally therefrom and bracketing said inner tines and said inner tine body with each said outer tine spaced from said inner tine body and a proximate one of said inner tines, each said outer tine having an upper portion proximate said upper portion of said attachment member that is wider than a remaining portion of said outer tine, said outer tines being resiliently compressible toward each other, each said outer tine further including a lower portion distal from said upper portion of said outer tine and containing a barb extending generally laterally from an outer edge of said lower portion with said barbs extending in opposing directions; and
means for attaching an article to said attachment member; and
said receiver including:
a planar member having a plurality of spaced openings extending therethrough for affixing said receiver to a device attachable to a garment on a body of a user;
a spaced pair of elongated opposing side walls, each said side wall attached with and extending generally laterally from an opposing side of said planar member, said side walls extending in substantially the same direction; and
a spaced pair of opposing flanges, said flanges extending inwardly generally laterally from respective said side walls, said flanges being oriented substantially parallel with and spaced from a front face of said planar member; and
said attachment mount when fully seated in said receiver having said barbs engaged with respective lower ends of said side walls of said receiver and said outer tines slidingly nested between said planar member and said flanges.

11. The system as defined in claim 10, further comprising an upstanding post member located adjacent and connected to a lower portion of said planar member for holding said attachment mount releasably engaged substantially within said side walls, said post member being straddled by said inner tines of said attachment mount to locate said inner tines on opposed surfaces of said post member.

12. The system as defined in claim 11, wherein said post member includes a spaced pair of shoulders disposed spacedly from said planar member for nesting said inner tines of said attachment mount between said shoulders and said planar member, said shoulders extending substantially toward respective said flanges, said shoulders being substantially parallel to said planar member.

13. The system as defined in claim 12, wherein:
said planar member of said receiver further includes an extended lower portion narrower in width than said planar member;
said extended lower portion having a bottom end substantially perpendicular to said side walls of said receiver and an integral ledge extending generally laterally from said bottom end in substantially the same direction as said side walls and generally perpendicular thereto, said ledge being located at a position at least equal to the location of lower tips of outside tines of an attachment mount to deter potential puncture incidents caused by lower tips of outside tines.

14. The system as defined in claim 13, wherein a rear face of said planar member of said receiver opposing said front face of said planar member includes a locking spline having a plurality of ridges and valleys extending radially, said spline being formed integrally with said rear face and surrounding an attaching hole extending through said planar member for affixing said receiver to a complemental spline on a device allowing said receiver to be affixed at a plurality of angles relative to such device.

15. The system as defined in claim 10, wherein said planar member includes a plurality of spaced openings therethrough to accommodate T-nut and bolt connectors for affixing said receiver to a device.

16. The system as defined in claim 10, further comprising:
a garment having a plurality of equally spaced, substantially horizontal webbings, each said webbing containing a plurality of spaced, equally sized loops, said loops of each said webbing being vertically aligned;
a device including a platform, said platform having a substantially planar plate member and at least two opposing pairs of spaced prongs for securing said plate member to said webbings of said garment, said plate member having a front surface, a rear surface, and a plurality of spaced openings extending through said plate member for affixing said receiver thereto, each prong of each said pair of prongs having a free distal end and an opposing proximal end attached to said rear surface of said plate member, with said free distal ends of a first said pair of prongs facing said distal ends of a second said pair of prongs, each said prong being spaced equidistant from said rear surface; and
said webbings being secured to said garment at equally spaced apart locations, said loops in each said webbing being at equally spaced apart locations, spacing between locations of said loops and spacing between locations of said webbings being substantially equal; a first prong of said first pair of prongs being received through a first loop of a first said webbing and an opposing first prong of said second pair of prongs being received through a first loop of a second said webbing; a second prong of said first pair of prongs being received through a second loop of said first webbing and an opposing second prong of said second pair of prongs being received through a second loop of said second webbing.

17. The system as defined in claim 10, further comprising:
a garment having a plurality of equally spaced, substantially horizontal webbings, each said webbing containing a plurality of spaced, equally sized loops, said loops of each said webbing being vertically aligned;
a device including a second said attachment mount; and
said webbings being secured to said garment at equally spaced apart locations, said loops in each said webbing being at equally spaced apart locations, spacing between locations of said loops and spacing between locations of said webbings being substantially equal to permit a pair of outer tines of said second attachment mount to be disposed through a pair of adjacent said loops of a first said webbing and through a pair of adjacent said loops of a second proximate said webbing substantially aligned vertically with said pair of adjacent loops of said first webbing, a barb of each said outer tine of said second attachment mount catching upon a lower edge of said second webbing upon passing of said barbs beyond said lower edge of said second webbing, a pair of inner tines of said second attachment mount to be disposed over said first webbing and through said pair of adjacent loops of said second webbing, an upper portion of an inner tine body of an attachment member of said second attachment mount distal from said inner tines of said second attachment mount overlaying said first webbing.

18. The system as defined in claim 10, further comprising:
a device including a second said attachment mount;
a second said receiver;
said second attachment mount when fully seated in said second receiver having barbs engaged with respective lower ends of side walls of said second receiver and outer tines of said second attachment mount slidingly nested between planar member of said second receiver and flanges of said second receiver; and
said planar member of said second receiver having a plurality of spaced openings extending therethrough for affixing said second receiver to a second device attachable to a garment on the body of a user.

19. The system as defined in claim 10, further comprising a device including a support to which said receiver is attached.

20. A method for removably securing articles to a device attachable to a garment on the body of a user, said method comprising the steps of:
A) affixing an article to an attachment mount by passing a fastener through an opening in the attachment mount and using the fastener to secure the article thereto;
B) affixing a device attachable to a garment to a receiver by passing a fastener through an opening in the receiver and using the fastener to secure the device to a rear face of the receiver;
C) inserting tips of outer tines of the attachment mount into the receiver and moving the attachment mount between side walls of the receiver, thereby compressing the outer tines inwardly between the side walls with the outer tines slidingly nested between flanges of the receiver and a planar member of the receiver until the outer tines spring outwardly to dispose each barb in engagement with a lower edge of a respective side wall.

21. The method as recited in claim 20, wherein step A includes the step of:
D) providing a plurality of spaced slots and holes in an upper portion of an attachment member of the attachment mount and a slot in an inner tine body of the attachment member of the attachment mount through which fasteners can pass and securing the article to the attachment mount at a plurality of angles relative thereto.

22. The method as recited in claim 20, wherein step A includes the step of:
D) providing in an inner tine body of an attachment member of the attachment mount a locking spline having a plurality of ridges and valleys extending radially, the spline surrounding an attaching hole through which a fastener can be passed and used to secure the article to the attachment mount at a plurality of angles relative thereto.

23. The method as recited in claim 20, wherein step B includes the step of:
D) providing in a rear face of the planar member of the receiver a locking spline having a plurality of ridges and valleys extending radially, the spline surrounding an attaching hole through which a fastener can be passed and used to secure the receiver to a complemental spline on the device at a plurality of angles relative to the device.

24. The method as recited in claim 20, wherein the device of step B is a platform, further comprising the steps of:
D) inserting a first pair of horizontally aligned prongs of the platform into respective spaced loops in a first horizontally disposed webbing of the garment;
E) partially horizontally folding a portion of the garment beneath the platform to permit opposing second pair of horizontally aligned prongs of the platform to be inserted into respective aligned loops in a second spaced horizontally disposed webbing of the garment; and
F) unfolding the garment to secure the platform and the affixed receiver, with the attachment mount and attached article, to the garment.

25. The method as recited in claim 24, wherein step D includes the steps of:
G) providing in a rear face of the planar member of the receiver a locking spline surrounding an attaching hole through which a fastener can be passed; and
H) providing in a front surface of a plate member of the platform a locking spline surrounding an attaching hole through which a fastener can pass and securing the platform to the locking spline of the receiver at a plurality of angles relative thereto.

26. The method as recited in claim 24, further comprising the step of:
G) removing the platform from the garment by partially horizontally folding the portion of the garment beneath the platform and selectively removing one of the pairs of prongs from the respective loops in a first horizontally disposed webbing of the garment and thereafter removing the remaining pair of prongs from the respective loops of a second spaced and horizontally disposed second webbing.

27. The method as recited in claim 20, wherein the device of step B is a second attachment mount, further comprising the steps of:
D) inserting tips of outer tines of the second attachment mount into an adjacent pair of spaced loops in a first horizontally disposed webbing of a garment;
E) angling outwardly tips of inner tines of the second attachment mount such that the inner tines pass over the top of the first webbing as the second attachment mount is moved toward adjacent loops of a second proximate webbing;
F) moving the second attachment mount to position the outer tines through the adjacent loops of the first webbing and into and through the pair of adjacent loops of the second webbing that are aligned vertically with the pair of loops of the first webbing; and
G) guiding the tips of the inner tines of the second attachment mount into the adjacent pair of loops of the second webbing, until the outer tines spring outwardly to dispose each barb in engagement with a lower edge of the second webbing at a respective spaced stitch area, thereby securing the second attachment mount, the receiver, the attachment mount, and the attached article to the garment.

28. The method as recited in claim 27, wherein step G includes straddling the stitch area between the adjacent loops of the second webbing by the space between the inner tines.

29. The method as recited in claim 27, further comprising the steps of:
H) providing in a rear face of the planar member of the receiver a locking spline surrounding an attaching hole through which a fastener can be passed; and
I) providing in an inner tine body of an attachment member of the second attachment mount a locking spline surrounding an attaching hole through which a fastener can pass and securing the receiver to the second attachment mount at a plurality of angles relative thereto.

30. The method as recited in claim 27, further comprising the step of:
H) compressing inwardly a lower portion of each outer tine of the second attachment mount such that the barb of the outer tine clears a respective proximate stitch area at the lower edge of the second webbing, and then withdrawing the second attachment mount upwardly out of both the second and first webbings, maintaining the compression of the outer tines until the outer tines and barbs are located in the loops of the first webbing.

31. The method as recited in claim 20, wherein the device of step B is a second receiver, further comprising the steps of:
D) providing a second receiver;
E) affixing a second device attachable to a garment to the second receiver by passing a fastener through an opening in the second receiver and using the fastener to secure the second device to a rear face of the second receiver;
F) inserting tips of outer tines of the second attachment mount into the second receiver and moving the second attachment mount between side walls of the second receiver, thereby compressing the outer tines inwardly between the side walls with the outer tines slidingly nested between flanges of the second receiver and a planar member of the second receiver until the outer tines of the second attachment mount spring outwardly to dispose each barb in engagement with a lower edge of a respective side wall.
